(19) United States
(12) Patent Application Publication
(10) Pub. No.: US 2013/0328811 A1
(43) Pub. Date: Dec. 12, 2013

(54) INTERACTIVE LAYER ON TOUCH-BASED DEVICES FOR PRESENTING WEB AND CONTENT PAGES

(71) Applicants: Assaf Henkin, Tel Aviv (IL); Yoav Shaham, Ramat Hasharon (IL); Itai Brickner, Tel Aviv (IL); Barak Shein, San Francisco, CA (US); Ammiel Kamon, San Francisco, CA (US)

(72) Inventors: Assaf Henkin, Tel Aviv (IL); Yoav Shaham, Ramat Hasharon (IL); Itai Brickner, Tel Aviv (IL); Barak Shein, San Francisco, CA (US); Ammiel Kamon, San Francisco, CA (US)

(73) Assignee: Kontera Technologies, Inc., San Francisco, CA (US)

(21) Appl. No.: 13/913,284

(22) Filed: Jun. 7, 2013

Related U.S. Application Data
(60) Provisional application No. 61/656,831, filed on Jun. 7, 2012.

(51) Int. Cl. G06F 3/041

(52) U.S. Cl. CPC G06F 3/041
USPC 345/173

(57) ABSTRACT

Techniques are described for selecting and providing enhanced, interactive content that can be displayed atop web-based content when presented via a touch-enabled display. The enhanced and interactive content is presented in an opener component that has a visual representation that is intended to convey a metaphorical representation of a real-world object, via which a user might naturally and intuitively interact via the touch-enabled display. When the opener component is invoked via a touch-based gesture, pre-loaded content may be presented, or additional functionality may be invoked.

### RELATED APPLICATIONS

The present application claims the benefit of priority of U.S. Provisional Patent Application No. 61/656,831, filed on Jun. 7, 2012, which is incorporated herein by reference in its entirety.

### TECHNICAL FIELD

The present disclosure generally relates to methods, systems and computer program products for enhancing web-based content presented via touch-enabled displays.

### BACKGROUND

Various techniques exist for enhancing web-based content when such content is presented via a web browser application residing and executing on a conventional desktop computer. For example, a web page presented in a web browser application of a traditional desktop computer may be analysed for the purpose of providing additional information meant to enhance the original content of the web page. Some of these techniques are described in greater detail in U.S. Pat. No. 7,284,008 entitled, “Dynamic Document Context Mark-Up Technique Implemented Over a Computer Network,” and U.S. Pat. No. 7,478,089, entitled “System and Method for Real-Time Web Page Context Analysis for the Real-Time Insertion of Textual Markup Objects and Dynamic Content.”

However, many new computing devices—particularly any number of mobile computing devices, including smartphones, tablet computing devices, media players, and so forth—include as the primary input device a touch-enabled display. For various reasons (e.g., battery life, size, and so forth) many of these mobile computing devices have limited resources when compared to their desktop counterparts. Consequently, some of the known techniques for presenting enhanced information with web-based content are not compatible with devices that have a touch-enabled display.

### BRIEF DESCRIPTION OF THE DRAWINGS

FIGS. 1A through 1G are example user interfaces consistent with various embodiments of the present invention.

FIG. 2 is an example of the method operations that occur during a user interaction with an opener component and corresponding layer of information and content.

FIG. 3 is an example of the factors considered when selecting content for presentation via an opener component with a particular web page or other web-based content, consistent with embodiments of the invention.

FIG. 4 is is a block diagram of a machine in the form of a computing device within which a set of instructions, for causing the machine to perform any one or more of the methodologies discussed herein, may be executed.

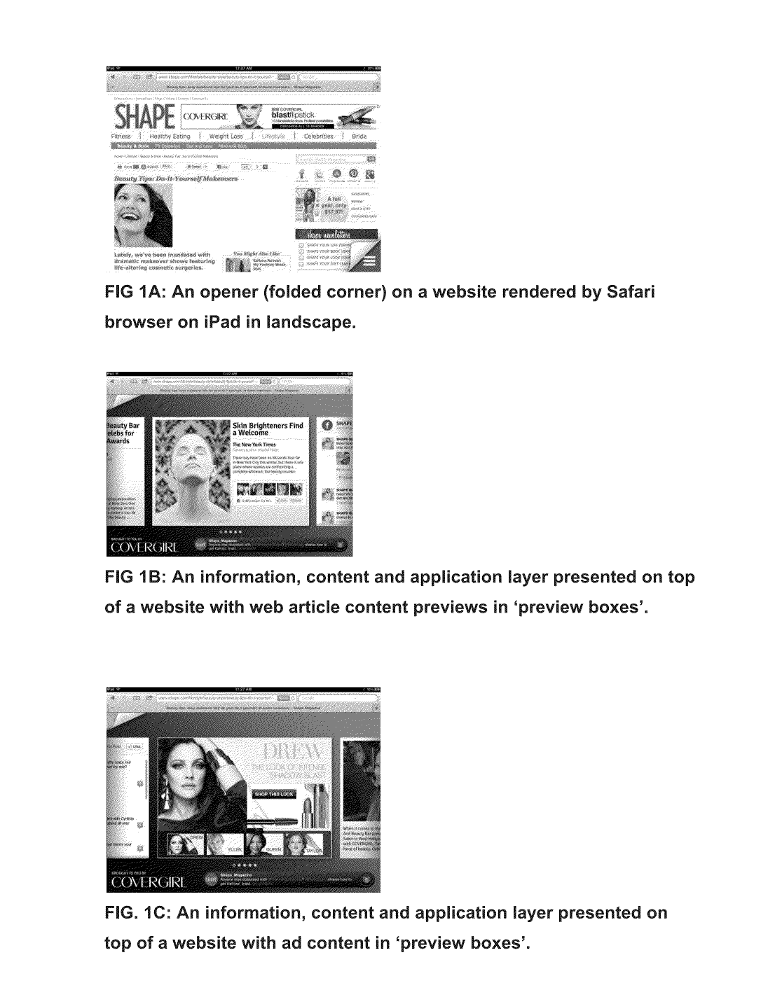

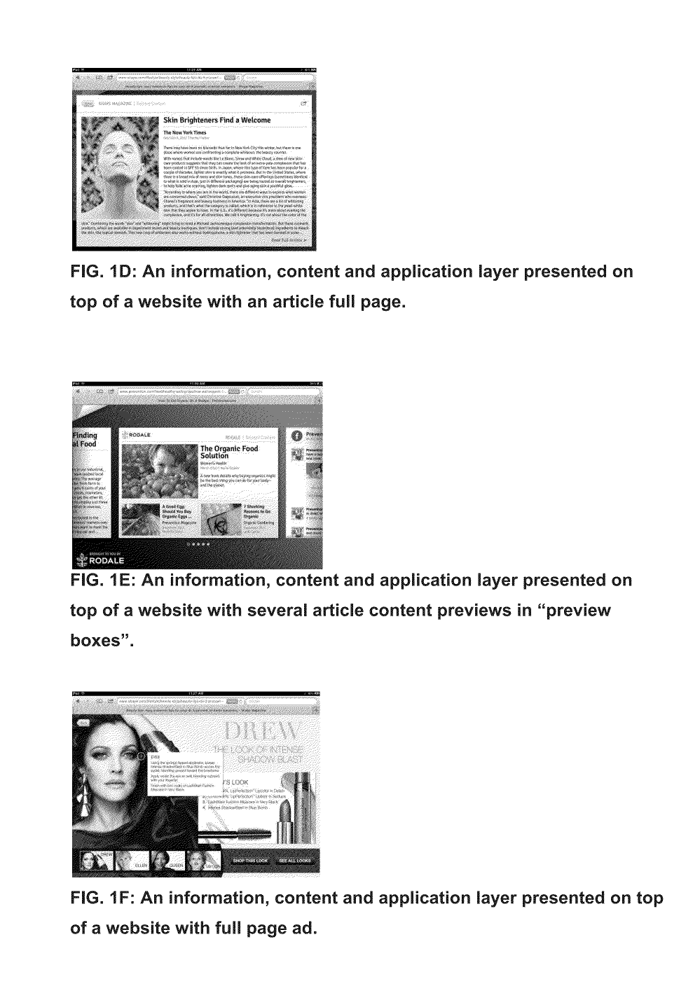

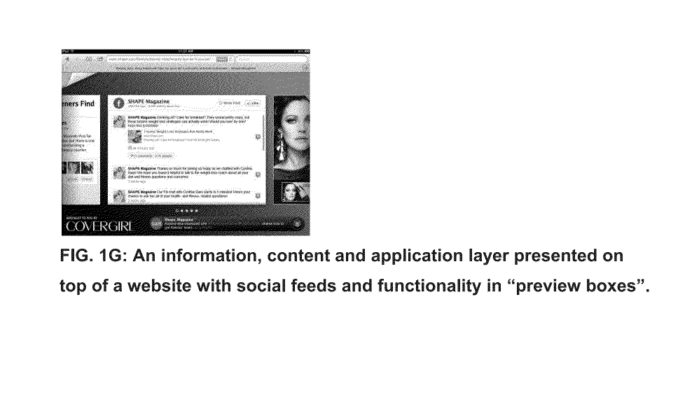

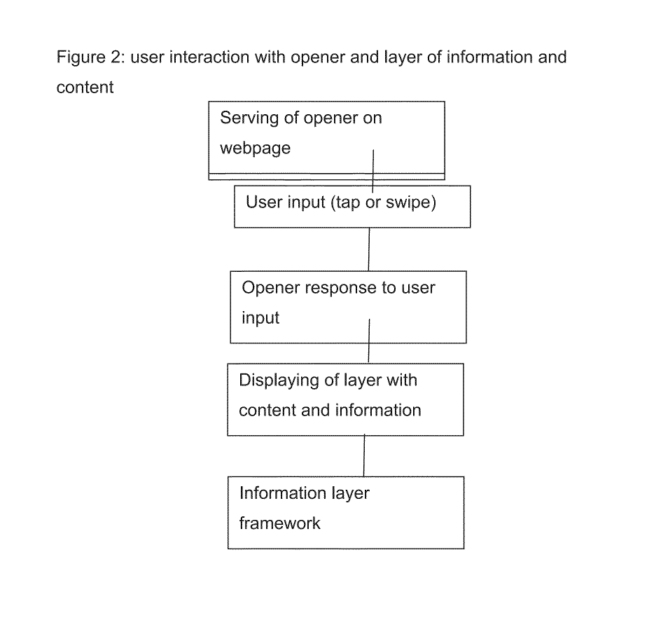

### SUMMARY

Users of touch-based devices can touch or swipe graphical elements on the device display to reveal interactive content and information in a new layer that is displayed on top of web pages, thus creating a page layer that adds information to the page, without taking space on that page besides the graphical opener element (we refer to this as “opener” in this document). Further, the layer containing the information can be swiped horizontally, vertically or in other directions to display more content and information in the layer. Further, the opening of the layer from the page can be displayed in a way that creates the illusion of page turning, among other transitions, to smoothly display the new layer using a metaphor of real world objects (such as page turning in a book). Further the contents of the layer can be as comprehensive as a collection of web applications (‘web apps’) and as focused as a full screen advertisement. Further, the layer can be loaded during the web page load into the browser so that tapping or swiping the opener displays the layer immediately without the need to load the contents of the layer upon touch. The invention described herein can be used in any touch based device such as mobile smartphones, tablets, car displays, TVs, music and entertainment players (such as the IPOD TOUCH®), navigation systems, laptops and desktops that have touch screens, and other computing devices that use a touch screen to receive user input.

### DESCRIPTION

Users are using more touch devices than before to access webpages or other content pages (i.e. smartphone browsers, tablet browsers, interactive televisions). When webpages are displayed on these devices, in what is currently referred to as ‘mobile web’ (or other content pages, for example, in interactive televisions, car computer systems) the touch screen interface adapts some of the user inputs from the desktop computer and pointer controller interface to touch screen (for example, a left mouse click on a link on a desktop with a mouse is adapted to a tap on the link on touch devices), as well as introduce new type of interface functionality that is not found on desktops (for example pinch to zoom, or shake device to undo), but many of the other attributes of the webpage (or other content page, such as content in an interactive television or in car computer devices) are not adapted by the touch screen device's operating system in a way that is optimized for touch screen devices and their usage by users. For example, web pages on touch devices are often scaled down to the device's screen, and by doing so create a small image of the site, that makes it hard for users to consume content. Further, users' expectations from touch screen devices have been set by applications that are developed for touch devices that provide easy to consume content and typically use metaphors to convey to users what can be achieved with these applications (see for reference apple's higuide, available at, “http://developer.apple.com/library/ios/#DOCUMENTATION/UserExperience/Con ceptual/MobileHIG/Introduction/Introduction.html”.

Further, some advertising forms developed for webpages displayed on touch devices use small banners to take users to advertisers' websites, but although they are small in size to adapt to smartphone displays, they use resized banners and other formats of desktop online advertising, and do not use metaphors to provide a touch input experience that conveys to users what can be achieved when tapping on them.

Embodiments of the inventive subject matter described herein, provide a way for users to access content of various types, including advertising, without leaving the webpage they are visiting (or other content page they are using) by using an intuitive motion on touch devices. This is made possible by serving an opener, a graphical prompter, that simulates and replicates the properties of a metaphor it is intended to replicate (for example, an opener replicating a notepad page that has a folded corner that can be swiped open by a page turn like gesture). The metaphoric nature of the opener enables it to be of small size and hence take small portions of the screen that are unused by the original website publisher's content.

The opener can be opened by interacting with it using motions and other inputs (such as gestures, device movement, sound input) When the opener is swiped open, content, information, and applied functionality is served and presented to users. Users can access this content in a new layer without having to point their browsers to a different website, which would require to wait for new site to load.

The content presented on the layer can include, but is not limited to, articles, videos, images, advertisements, information feeds from social networks, web applications (computer programs that provide functionality either independently or using a server). Selection of the content presented can be based, in some embodiments of the invention, on similarity usage patterns of other users that have similar usage patterns to those of the user, and/or similarity to the content on the webpage (or content in the other content page, or descriptive content about the other content page, such as a description or transcription of a TV program shown on an interactive television) the opener was presented on, and/or selected in other methods. Further, embodiments of the invention provide users with functionality that lets them write, query, and publish to databases and online services such as map applications for directions and social networks, and send and perform social functionality (such as ‘retweet’ on TWITTER®) from the layer. The supplemental content and functionality can be pre-loaded in full or part while users visit the main webpage (or the other content page).

Embodiments of the present invention let website publishers, in some instances, promote their own content that is related to the article on which the opener has been placed, and in some instances of the invention can let publishers select what content sources from other content providers will be presented, or blocked from being presented, in the invention as found on their site.

Embodiments of the present invention let users of touch devices interact with web served content and functionality in a layer that logically resides on top of the website, and in some instances of the invention can serve as a web based virtual desktop that contains content and applications, that is launched from the webpage (or the other content page), and is accessed from a variety of websites.

The content selection method that the invention uses to select articles and objects to be presented in the invention uses content relevance, user selections, user classification into clusters of users with similar selections, device, time of day, location, article popularity score, topics, image analysis, content analysis, topical and categorical classification of text, image and video content.

The invention described contains novel and unique innovations that are comprised of the collection of the various components that are being claimed, and of various combinations that create a unique way of presenting content, information, and applications to users on touch devices.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

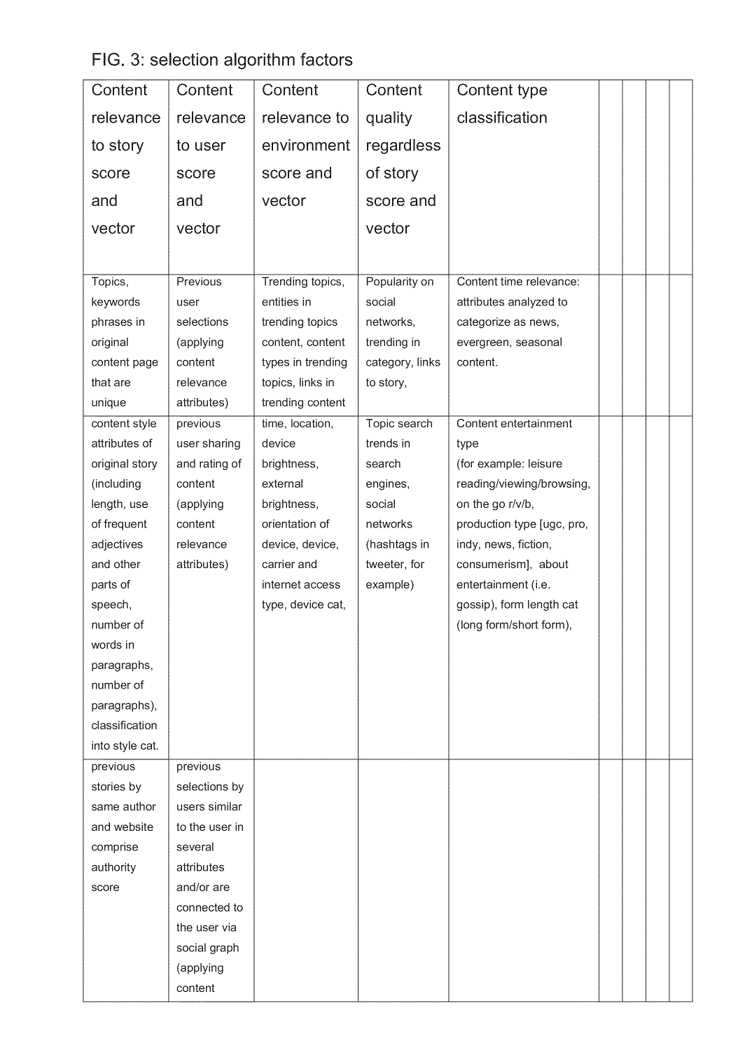

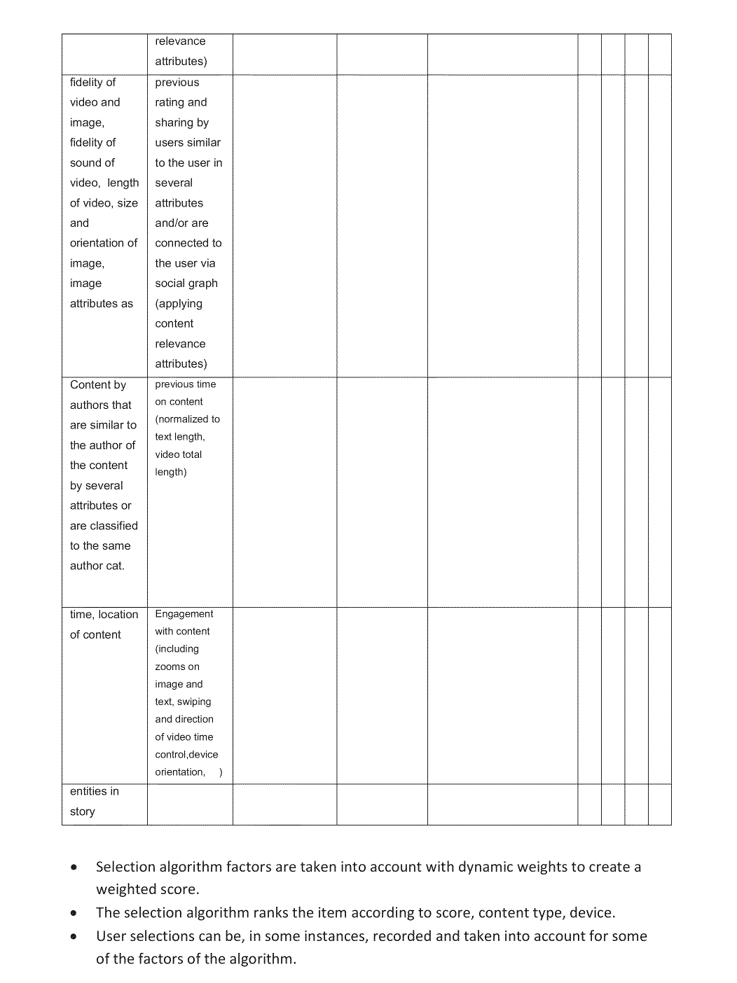

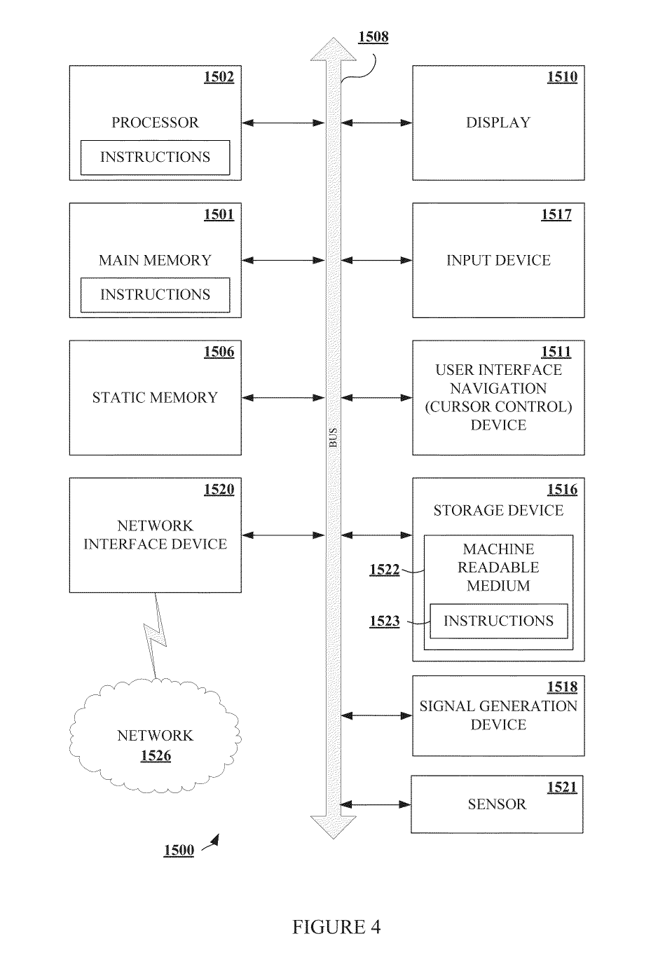

FIG. 3 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A computer-implemented method comprising:
communicating, by a processor-based web server, to a client computing device having a touch-enabled display a web page and an opener component, the opener component i) providing the end-user with an interactive graphical layer presented on top of the web page, ii) having a visual appearance intended to convey a metaphorical representation of an object with which the end-user can interact via the touch-enabled display, and including content that is stored in memory of the client computing device until detecting that an end-user has invoked functionality of the opener component by performing a gesture via the touch-enabled display.
